(19) United States
(12) Patent Application Publication
(10) Pub. No.: US 2022/0405834 A1
(43) Pub. Date: Dec. 22, 2022

(54) AUCTIONING A WAIT TIME OF A USER OF A VEHICLE

(71) Applicant: Reid C. Anthony, Albany, NY (US)

(72) Inventor: Reid C. Anthony, Albany, NY (US)

(21) Appl. No.: 17/805,477

(22) Filed: Jun. 6, 2022

Related U.S. Application Data
(60) Provisional application No. 63/211,109, filed on Jun. 16, 2021.

(51) Int. Cl. G06Q 30/08; G06Q 20/10; G06Q 10/02; G08G 1/14

(52) U.S. Cl. CPC G06Q 30/08; G06Q 20/102; G06Q 10/02; G08G 1/144; G08G 1/146

(57) ABSTRACT

A method for auctioning a wait time of a user of a vehicle parked in an available parking space includes: posting details regarding the available parking space; posting, by a user of at least one unparked vehicle, a requirement for a parking space in a designated area; matching the designated area with the location of the available parking space, the matching determining a list of unparked vehicles having a requirement for the available parking space; presenting information regarding the available parking space to the user of each unparked vehicle on the list of unparked vehicles; bidding, by the user of at least one unparked vehicle on the list of unparked vehicles, on the wait time of the user of vehicle parked in the available parking space; determining a winning bid; and notifying the user of the unparked vehicle who placed the winning bid.

### TECHNICAL FIELD

The present invention relates generally to auctions and parking spaces, and more particularly, to a method, system, and computer program product for locating and managing parking spaces by auctioning waiting times.

### BACKGROUND

Finding a parking space in densely populated areas or in areas with limited off-street parking can be a time consuming and frustrating task. In some cases, a driver of a vehicle may wait at a location hoping that a nearby parking space becomes available. In other cases, a driver of a vehicle may repeatedly circle an area until a parking space opens up in front of them. Often, however, finding a good parking space is just a matter of luck (i.e., being at the right location at the right time).

### SUMMARY

A first aspect of the invention provides a method for auctioning a wait time of a user of a vehicle parked in an available parking space at a location, including: posting details regarding the available parking space, the posting including providing the location of the available parking space, a size of the available parking space, and a wait time the user of the vehicle parked in the available parking space is willing to hold the available parking space; posting, by a user of at least one unparked vehicle, a requirement for a parking space in a designated area; matching the designated area posted by the user of each unparked vehicle with the location of the available parking space, the matching determining a list of unparked vehicles having a requirement for the available parking space; presenting information regarding the available parking space to the user of each unparked vehicle on the list of unparked vehicles; bidding, by the user of at least one unparked vehicle on the list of unparked vehicles, on the wait time of the user of vehicle parked in the available parking space; determining a winning bid for the wait time of the user of the vehicle parked in the available parking space; and notifying the user of the unparked vehicle who placed the winning bid.

A second aspect of the invention provides a computerized system for auctioning a wait time of a user of a vehicle parked in an available parking space at a location by performing a method, the method including: posting details regarding the available parking space, the posting including providing the location of the available parking space, a size of the available parking space, and a wait time the user of the vehicle parked in the available parking space is willing to hold the available parking space; posting, by a user of at least one unparked vehicle, a requirement for a parking space in a designated area; matching the designated area posted by the user of each unparked vehicle with the location of the available parking space, the matching determining a list of unparked vehicles having a requirement for the available parking space; presenting information regarding the available parking space to the user of each unparked vehicle on the list of unparked vehicles; bidding, by the user of at least one unparked vehicle on the list of unparked vehicles, on the wait time of the user of vehicle parked in the available parking space; determining a winning bid for the wait time of the user of the vehicle parked in the available parking space; and notifying the user of the unparked vehicle who placed the winning bid.

A third aspect of the invention provides a computer program product stored on a computer readable storage medium, which when executed by a computer system, performs a method for auctioning a wait time of an user of a vehicle parked in an available parking space at a location, the method including: posting details regarding the available parking space, the posting including providing the location of the available parking space, a size of the available parking space, and a wait time the user of the vehicle parked in the available parking space is willing to hold the available parking space; posting, by a user of at least one unparked vehicle, a requirement for a parking space in a designated area; matching the designated area posted by the user of each unparked vehicle with the location of the available parking space, the matching determining a list of unparked vehicles having a requirement for the available parking space; presenting information regarding the available parking space to the user of each unparked vehicle on the list of unparked vehicles; bidding, by the user of at least one unparked vehicle on the list of unparked vehicles, on the wait time of the user of vehicle parked in the available parking space; determining a winning bid for the wait time of the user of the vehicle parked in the available parking space; and notifying the user of the unparked vehicle who placed the winning bid.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description taken in conjunction with the accompanying drawings that depict various aspects of the invention.

FIG. 1 depicts a computerized environment for locating and managing parking spaces by auctioning waiting times according to embodiments.

FIG. 2 depicts a process according to embodiments.

FIGS. 3-8 depict an auction application on a mobile device according to embodiments.

FIG. 9 depicts a processing system according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

The present invention relates generally to parking spaces, and more particularly, to a method, system, and computer program product for locating and managing parking spaces by auctioning waiting times.

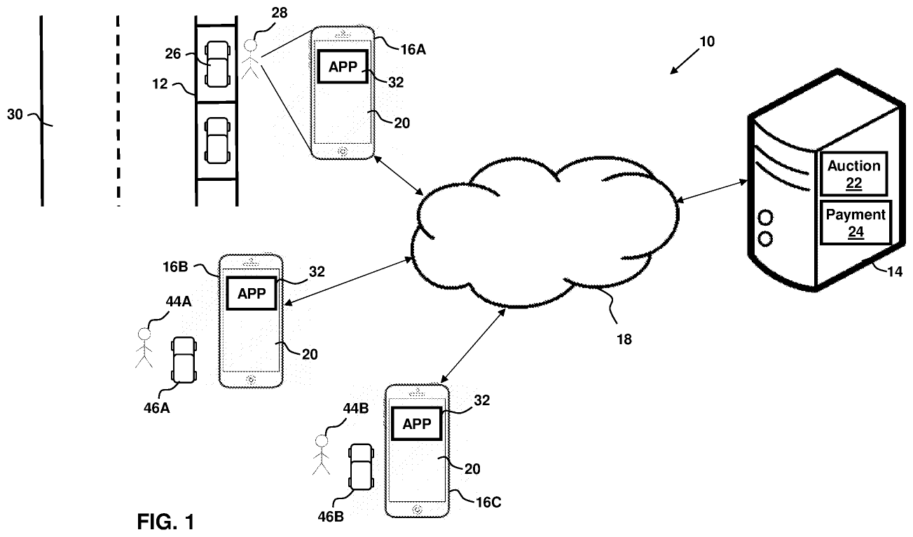

FIG. 1 depicts a computerized environment 10 for locating and managing parking spaces 12 by auctioning waiting times according to embodiments. The computer environment 10 generally includes a computer system 14 (e.g., a server) connected to a plurality of mobile devices 16 (e.g., mobile devices 16A, 16B, 16C in FIG. 1) via a network 18. The network may include, for example, a Local Area Network (LAN), Wide Area Network (WAN), intranet, the Internet, and/or the like. The computer system 14 may be configured to obtain and process information from external sources including, for example, mobile devices 16.

The mobile device 16 may be a mobile phone, a tablet, and/or the like, and may be used to send and receive information to/from the computer system 14 via the network 18. Each mobile device 16 may have a display screen 20 for displaying information to a user and a physical or virtual keyboard for entering information into the mobile device 16.

The computer system 14 includes an auction module 22 and a payment module 24. The auction module 22 manages the auctions described herein, while the payment module 24 manages the financial aspects of the auctions.

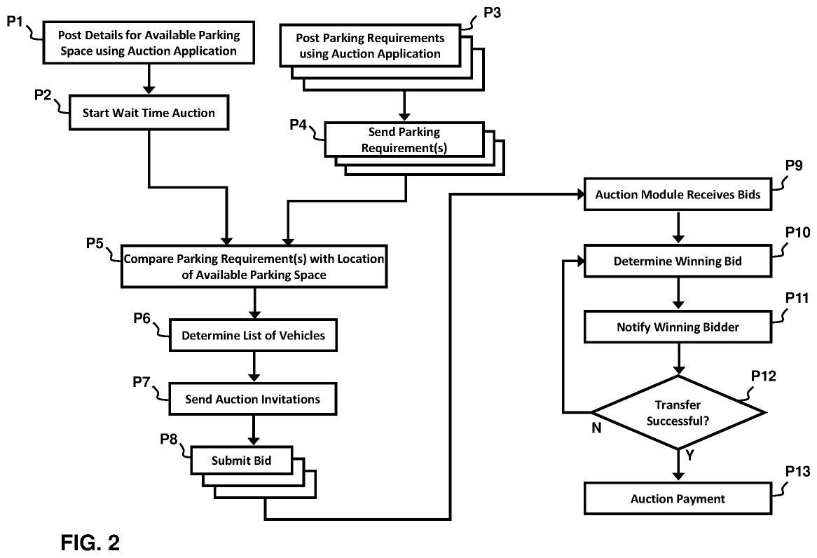

According to embodiments, there is provided a method for auctioning a wait time of a user (e.g., occupant, owner, etc.) of a vehicle parked in a parking space. A flow diagram of the auction process is provided in FIG. 2, and will be described with reference to FIG. 1 and FIGS. 3-8.

As depicted in FIG. 1, a vehicle 26 may be parked in a parking space 12 along a street 30. When a user 28 of the vehicle 26 parked in the parking space 12 is ready to vacate the parking space 12 occupied by the vehicle 26, the user 28 accesses an auction application 32. The auction application 32 may be accessed on the mobile device 16A, through a web browser running on the mobile device 16A, or in any other suitable manner.

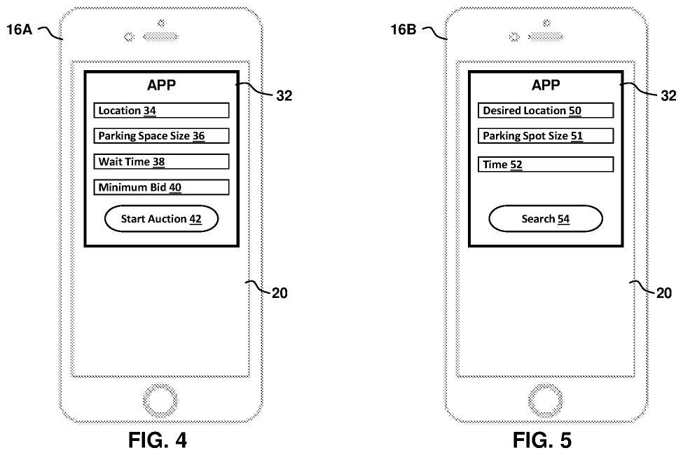

After accessing the auction application 32, the user 28 of the vehicle 26 parked in the parking space 12 posts auction details (process P1) regarding the soon to be available parking space 12 using the auction application 32. The details of the available parking space 12 may include, for example, as shown in FIG. 4, location data 34 regarding the location of the available parking space 12, size data 36 of the available parking space 12, and a wait time 38 the user 28 of the vehicle 26 parked in the available parking space 12 is willing to hold the available parking space 12 for the auction.

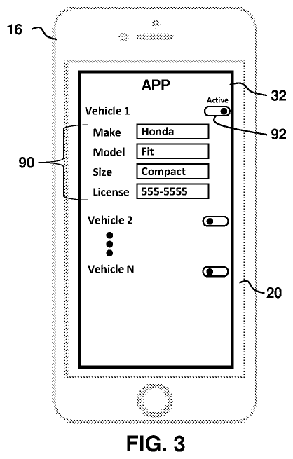

As depicted in FIG. 3, characteristics 90 of the vehicle 26, including the make, model, size, and color of the vehicle 26, may be registered with the auction application 32 prior to the start of an auction (e.g., prior to creating an auction). The license plate information of the vehicle 26 may also be provided. Multiple vehicles 26 may be registered with the auction application 32. In such a case, one of the registered vehicles 26 may be indicated as being “active” (e.g., via a toggle switch 92) prior to creating an auction for a parking space 12. The auction application 32 may also default, for example, to the first listed vehicle 26, if desired.

The location data 34 may be provided, for example, using global positioning system (GPS) data provided by the mobile device 16A, may be inputted manually into the auction application 32 (e.g., Main Street between 5^{th} and 6^{th} Avenues), may be accessed through a map application on the mobile device 16A (which may be integrated into the auction application 32), or in any other suitable manner. The size data 36 may indicate the size of a vehicle that can fit in the available parking space 12, for example, compact car, full size car, truck, etc. The wait time 38 the user 28 of the vehicle 26 parked in the available parking space 12 is willing to hold the available parking space 12 may be expressed, for example, in units of time (e.g., 10 minutes). A minimum bid amount 40 may also be provided (e.g., $20, $10/10 minutes, $1/minute, etc.). Once the details regarding the available parking space 12 have been suitably entered into the auction application 32, the user 28 directs the auction application 32 at process P2 to send (publish) the auction details to the auction module 22 running on the computer system 14. This may be achieved, for example, by pressing a “Start Auction” button 42 or the like. The auction details may be edited/updated by the user 28 at any time prior to the publishing of the auction details to the auction module 22.

At some point, after the details regarding the available parking space 12 have been sent to the auction module 22 running on the computer system 14, a user 44 (e.g., 44A, 44B in FIG. 1) of one or more unparked vehicles 46 (e.g., 46A, 46B in FIG. 1) posts (process P3) a parking requirement to the auction module 22 for a parking space in a designated area, again using an auction application 32 running on a respective mobile device 16. As depicted in FIG. 5, for example, the parking requirement may include details such as, for example, location data 50 regarding a designated area in which a parking space 12 is desired, a parking space size requirement 51 of the vehicle 46, as well as a desired time 52 of availability of the parking space 12. The location data 50 may be provided, for example, using GPS data provided by the mobile device 16, may be inputted manually into the auction application 32 (e.g., Main Street between 5^{th} and 6^{th} Avenues), may be accessed using a map application on the mobile device 16 (which may be integrated into the auction application 32), or in any other suitable manner. The desired time 52 may be entered as a particular time (e.g., 11:00 AM) or a period of time (e.g., 11:00 AM-11:30 AM), or in any other suitable manner. Once the details regarding the desired parking space 12 have been suitably entered into the auction application 32, the user 44 directs the auction application 32 (e.g., by pressing a “Search Parking Spaces” button 54 or the like) to send (process P4) the details of the parking requirement to the auction module 22 running on the computer system 14.

At process P5, the auction module 22 compares the details of the received parking requirements with the details of the available parking space 12 and, based on the comparison, determines (process P6) a list of unparked vehicles 46 that may be interested in bidding on the wait time of the user 28 of the vehicle 26 parked in the available parking space 12. The comparison may include, for example, ranking the unparked vehicles 46 based on how closely the submitted parking requirements match the details of the available parking space 12 and selecting those unparked vehicles 46 that have a certain minimum degree of matching. The auction module 22 then invites (process P7) the user 44 of each unparked vehicle 46 on the list of unparked vehicles 46, via the corresponding mobile devices 16 to enter an auction for the wait time of the user 28 of the vehicle 26 currently parked in the available parking space 12.

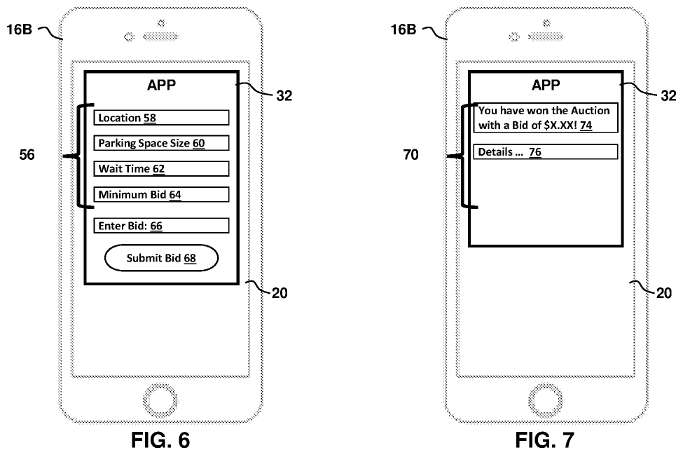

An example of such an invitation 56 displayed on the mobile device 16B of the user 44A of the unparked vehicle 46A is depicted in FIG. 6. As shown, according to embodiments, the invitation 56 includes location data 58 specifying the location of the available parking space 12, a description 60 of the size of the available parking space 12, the wait time 62 the user 28 of the vehicle 26 parked in the available parking space 12 is willing to hold the available parking space 12, and a minimum bid 64, if any. The user 44 of each unparked vehicle 46 on the list of unparked vehicles 46 may, in response to receipt of the invitation 56, enter a bid 66 for the wait time of the user 28 of the vehicle 26 currently parked in the available parking space 12. The bid 66 may then be sent (process P8) by pressing a “Submit Bid” button 68 or the like to the auction module 22 running on the computer system 14.

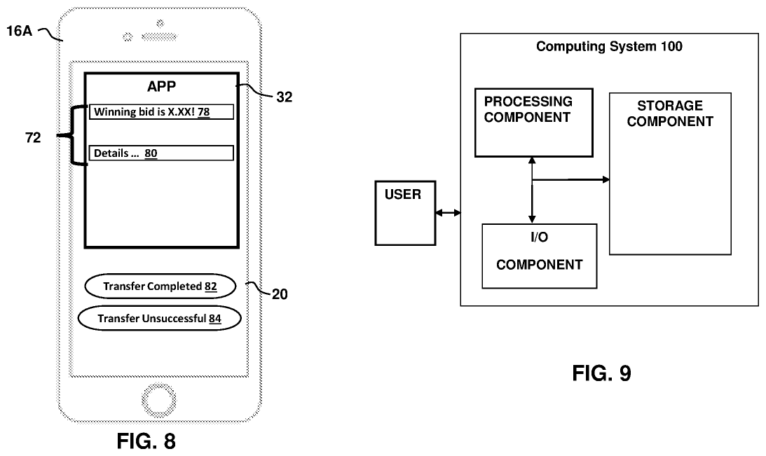

The bid(s) 66 are received by the auction module 22 at process P9. At process P10, the auction module 22 determines a winning (e.g., highest) bid, which should be greater than the minimum bid, for the wait time of the user 28 of the vehicle 26 parked in the available parking space 12. At process P11, the auction module 22 sends a notification 70 (see FIG. 7) to the user 44 of the unparked vehicle 46 that placed the winning bid, and sends a notification 72 (FIG. 8) to the user 28 of the vehicle 26 parked in the available parking space 12. The notification 70 may include, for example, details 74 regarding the winning bid, along with details 76 regarding the specific location of the available parking space 12, the vehicle 26 parked in the available parking space 12 (e.g., make, model, color, license plate number etc.), the user 28 of the vehicle 26 parked in the available parking space 12 (e.g., name, phone number, picture, etc.), and/or the like. The winning bidder may then drive to the location of the available parking space 12, where transfer of the available parking space 12 may occur.

In a similar manner, as depicted in FIG. 8, the notification 72 may include, for example, details 78 regarding the winning bid, along with details 80 regarding the user 44 of the unparked vehicle 46 who placed the winning bid. The details 80 may include, for example, information regarding the user 44 who placed the winning bid (e.g., name, phone number, picture, etc.), a description of the unparked vehicle 46 (e.g., make, model, color, license plate number etc.), and/or the like.

If the transfer of the available parking space 12 is successful (YES, P12), the auction module 22 coordinates with the payment module 24 to complete the auction payment process (process P13). This may include, for example, compensating the user 28 of the vehicle 26 previously parked in the available parking space 12 an amount corresponding to the winning bid, and debiting the user 44 of the now parked vehicle 46 who placed the winning bid an amount corresponding to the winning bid. A successful transfer may be indicated by the user 28 of the vehicle 26 previously parked in the available parking space 12 by actuating a “Transfer Completed” button 82 (FIG. 8). If the transfer of the available parking space 12 is not successful (NO, P12), flow returns to process P10 where another (e.g., next highest) winning bid is determined. An unsuccessful transfer may be indicated by the user 28 of the vehicle 26 parked in the available parking space 12 by actuating a “Transfer Unsuccessful” button 84 (FIG. 8).

According to embodiments, prior to participating in an auction, each user of the auction application 32 generally sets up an account with the auction and payment modules 22, 24. This will generally include setting up a username/password, entering user and vehicle details, and funding the account. Funding of the account may include, for example, depositing money in an account controlled by the payment module 24, or providing access to a credit card or an external financial account at a bank or other payment service (e.g., PayPal, Venmo, etc.). A minimum initial deposit may be required. Other payment protocols may also be used.

The payment module 24 is configured to credit the account of the user 28 of the vehicle 26 previously parked in the parking space 12 an amount corresponding to the winning bid. In addition, the payment module 24 is configured to debit the account of the user 44 of the now parked vehicle 46 who placed the winning bid an amount corresponding to the winning bid. Further, the payment module may debit a service fee (e.g., 10%, $5, etc.) from the account of at least one of the user 28 of the vehicle 26 previously parked in the parking space 12 and the account of the user 46 of the now parked vehicle 46 who placed the winning bid.

In general, the auction process depicted in FIG. 2 may receive a plurality of auctions for a plurality of different available parking spaces 12. As such, process P5 may compare the parking requirements of each user 44 with the auction details of a plurality of auctions for available parking spaces 12. The user 44, therefore, may receive a plurality of invitations 56 at process P7 to submit bids for a plurality of available parking spaces. The user 44 may then submit bids in multiple auctions at process P8 in response to the invitations 56. In response to the first winning bid, the remaining auction bids placed by the user 44 may be cancelled.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the program product of the present invention may be manually loaded directly in a computer system via a storage medium such as a CD, DVD, etc., the program product may also be automatically or semi-automatically deployed into a computer system by sending the program product to a central server or a group of central servers. The program product may then be downloaded into client computers that will execute the program product. Alternatively the program product may be sent directly to a client system via e-mail. The program product may then either be detached to a directory or loaded into a directory by a button on the e-mail that executes a program that detaches the program product into a directory. Another alternative is to send the program product directly to a directory on a client computer hard drive.

FIG. 9 depicts an illustrative processing system 100 (e.g., within a mobile device) for implementing one or more portions of the present invention, according to embodiments. The processing system 100 may comprise any type of computing device and, and for example includes at least one processor, memory, an input/output (I/O) (e.g., one or more I/O interfaces and/or devices), and a communications pathway. In general, processor(s) execute program code, which is at least partially fixed in memory. While executing program code, processor(s) can process data, which can result in reading and/or writing transformed data from/to memory and/or I/O for further processing. The pathway provides a communications link between each of the components in processing system 100. I/O can comprise one or more human I/O devices, which enable a user to interact with processing system 100.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. A method for auctioning a wait time of a user of a vehicle parked in an available parking space at a location, comprising:
posting details regarding the available parking space, the posting including providing the location of the available parking space, a size of the available parking space, and a wait time the user of the vehicle parked in the available parking space is willing to hold the available parking space;
posting, by a user of at least one unparked vehicle, a requirement for a parking space in a designated area;
matching the designated area posted by the user of each unparked vehicle with the location of the available parking space, the matching determining a list of unparked vehicles having a requirement for the available parking space;
presenting information regarding the available parking space to the user of each unparked vehicle on the list of unparked vehicles;
bidding, by the user of at least one unparked vehicle on the list of unparked vehicles, on the wait time of the user of vehicle parked in the available parking space;
determining a winning bid for the wait time of the user of the vehicle parked in the available parking space; and
notifying the user of the unparked vehicle who placed the winning bid.

2. The method of claim 1, further comprising:
confirming a transfer of the available parking space from the user of the vehicle parked in the available parking space to the user of the unparked vehicle who placed the winning bid; and
compensating the user of the vehicle parked in the available parking space in accordance with the winning bid.

3. The method of claim 2, wherein compensating the user of the vehicle parked in the available parking space further includes:
crediting an account of the user of the vehicle parked in the available parking space with an amount corresponding to the winning bid; and
debiting an amount corresponding to the winning bid from an account of the user of the unparked vehicle who placed the winning bid.

4. The method of claim 3, wherein the crediting and debiting is provided by a payment service.

5. The method of claim 4, wherein the payment service debits a service fee from at least one of the account of the user of the vehicle parked in the available parking space and the account of the user of the unparked vehicle who placed the winning bid.

6. The method of claim 4, further comprising establishing each account with the payment service.

7. The method of claim 6, further comprising funding each account with a predetermined minimum amount of money.

8. The method according to claim 1, carried out using an application running on a plurality of mobile devices communicating with a computer system over a network.

9. The method according to claim 8, further comprising displaying the location of the available parking space on a graphical user interface of at least one of the mobile devices.

10. The method according to claim 9, further comprising displaying, on the graphical user interface, the size of the available parking space, the wait time the user of the vehicle parked in the available parking space is willing to hold the available parking space, and information regarding the user of the vehicle parked in the available parking space.

11. The method according to claim 8, further comprising displaying, on the graphical user interface of at least one of the mobile devices, information regarding the user of the unparked vehicle who placed the winning bid.

12. A computerized system for auctioning a wait time of a user of a vehicle parked in an available parking space at a location by performing a method, carried out using an application running on a plurality of mobile devices communicating with a computer system over a network, the method comprising:
posting details regarding the available parking space, the posting including providing the location of the available parking space, a size of the available parking space, and a wait time the user of the vehicle parked in the available parking space is willing to hold the available parking space;
posting, by a user of at least one unparked vehicle, a requirement for a parking space in a designated area;
matching the designated area posted by the user of each unparked vehicle with the location of the available parking space, the matching determining a list of unparked vehicles having a requirement for the available parking space;
presenting information regarding the available parking space to the user of each unparked vehicle on the list of unparked vehicles;
bidding, by the user of at least one unparked vehicle on the list of unparked vehicles, on the wait time of the user of vehicle parked in the available parking space;
determining a winning bid for the wait time of the user of the vehicle parked in the available parking space; and
notifying the user of the unparked vehicle who placed the winning bid.

13. The computerized system of claim 12, wherein the method performed by the computerized system further comprises:
confirming a transfer of the available parking space from the user of the vehicle parked in the available parking space to the user of the unparked vehicle who placed the winning bid; and
compensating the user of the vehicle parked in the available parking space in accordance with the winning bid.

14. The computerized system of claim 12, wherein the method performed by the computerized system further comprises displaying the location of the available parking space on a graphical user interface of at least one of the mobile devices.

15. The computerized system of claim 12, wherein the method performed by the computerized system further comprises displaying, on a graphical user interface of at least one of the mobile devices, the size of the available parking space, the wait time the user of the vehicle parked in the available parking space is willing to hold the available parking space, and information regarding the user of the vehicle parked in the available parking space.

16. The computerized system of claim 12, wherein the method performed by the computerized system further comprises displaying, on a graphical user interface of at least one of the mobile devices, information regarding the user of the unparked vehicle who placed the winning bid.

17. A computer program product stored on a computer readable storage medium, which when executed by a computer system, performs a method for auctioning a wait time of a user of a vehicle parked in an available parking space at a location, the method comprising:
posting details regarding the available parking space, the posting including providing the location of the available parking space, a size of the available parking space, and a wait time the user of the vehicle parked in the available parking space is willing to hold the available parking space;
posting, by a user of at least one unparked vehicle, a requirement for a parking space in a designated area;
matching the designated area posted by the user of each unparked vehicle with the location of the available parking space, the matching determining a list of unparked vehicles having a requirement for the available parking space;
presenting information regarding the available parking space to the user of each unparked vehicle on the list of unparked vehicles;
bidding, by the user of at least one unparked vehicle on the list of unparked vehicles, on the wait time of the user of vehicle parked in the available parking space;
determining a winning bid for the wait time of the user of the vehicle parked in the available parking space; and
notifying the user of the unparked vehicle who placed the winning bid.

18. The computer program product of claim 17, wherein the method further comprises:
confirming a transfer of the available parking space from the user of the vehicle parked in the available parking space to the user of the unparked vehicle who placed the winning bid; and
compensating the user of the vehicle parked in the available parking space in accordance with the winning bid.

19. The computer program product of claim 17, wherein the method further comprises displaying, on a graphical user interface of at least one of a plurality of mobile devices, the location of the available parking space, the size of the available parking space, the wait time the user of the vehicle parked in the available parking space is willing to hold the available parking space, and information regarding the user of the vehicle parked in the available parking space.

20. The computer program product of claim 17, wherein the method further comprises displaying, on a graphical user interface of at least one of a plurality of mobile devices, information regarding the user of the unparked vehicle who placed the winning bid.
